(19) United States
(12) Patent Application Publication
(10) Pub. No.: US 2018/0147551 A1
(43) Pub. Date: May 31, 2018

(54) SUPERCRITICAL VESSEL AND RELATED METHODS OF SEPARATING DISSOLVED SOLIDS FROM A FLUID

(71) Applicant: Ohio University, Athens, OH (US)

(72) Inventor: Jason Patrick Trembly, Athens, OH (US)

(21) Appl. No.: 15/570,842

(22) PCT Filed: May 4, 2016
(86) PCT No.: PCT/US2016/030740

§ 371 Date: Oct. 31, 2017

Related U.S. Application Data
(60) Provisional application No. 62/156,531, filed on May 4, 2015.

(51) Int. Cl. B01J 3/00; C02F 1/78; C02F 1/28; C02F 1/32; C02F 1/20; C02F 11/08; C02F 1/38; C02F 5/02; C02F 1/66; C02F 101/00; C02F 103/10

(52) U.S. Cl. CPC B01J 3/008; C02F 1/78; C02F 1/28; C02F 1/32; C02F 1/20; C02F 2103/10; C02F 1/38; C02F 5/02; C02F 1/66; C02F 2101/006; C02F 11/086

(57) ABSTRACT

A supercritical vessel for separating dissolved solids from a fluid solution includes a main body defining a separation chamber adapted to contain a fluid solution while the fluid solution is heated to a supercritical temperature so as to produce a supercritical fluid from which dissolved solids precipitate. The vessel further includes a fluid inlet for receiving fluid solution, a fluid outlet for discharging supercritical fluid, and a precipitate outlet for discharging precipitated solids. The main body is tilted at a tilt angle relative to horizontal such that the fluid inlet is positioned vertically higher than the fluid outlet and the precipitate outlet, so as to induce movement of the precipitated solids in a downward direction toward the precipitate outlet. The fluid inlet may be positioned proximate a first end of the main body, and the fluid outlet and precipitate outlet may be positioned proximate a second end.

### CROSS-REFERENCE TO RELATED APPLICATION

This application claims priority to U.S. Provisional Application Ser. No. 62/156,531, filed May 4, 2015, the disclosure of which is hereby incorporated by reference herein in its entirety.

### BACKGROUND

Management of flowback and produced (F/P) water from conventional and unconventional oil and gas wells generated during hydraulic fracturing has been deemed by the U.S. Department of Energy as the largest volume waste stream associated with oil and gas production. With increased oil and gas production from unconventional resources, F/P water management is a growing concern worldwide. In 2007, oil and gas fields produced over 80 billion barrels of F/P water requiring processing. Global cost estimates stemming from F/P water management are more than $40 billion annually, with water transportation costs accounting for an additional $20 billion annually.

Within North America, tremendous growth in oil and gas production has been realized through the development of unconventional shale reservoirs. Two significant obstacles to continued unconventional shale development are the availability of water for drilling and hydrofracturing and management of F/P water from unconventional wells. During development of a horizontal well, 1 to 6 million gallons of fresh water may be used to stimulate the shale formation. The fracturing fluid is typically composed of approximately 90.6 wt % water, 9.0 wt % proppant, and 0.4 wt % of additives. Up to 750 chemicals have been used as additives for fracturing fluid and consist of acids, biocides, breakers, clay stabilizers, corrosion inhibitors, crosslinkers, friction reducers, gelling agents, iron control, pH control, scale inhibitors, and surfactants. After fracturing, over 1 million gallons of F/P water is generated from each well, which must then be transported offsite for proper disposal.

F/P water contains a variety of components from both the fracturing fluid and shale formation. Table 1 presents a summary of some of the components and concentration ranges found in F/P water. The compositions of F/P water are quite different and both can vary with time and location. In general, flowback water typically contains higher hydrocarbon and chemical compositions due to its fracturing fluid content, while produced water contains higher total dissolved solids (TDS) from the shale formation. Hydrocarbons and chemicals found in F/P water are both polar and non-polar in nature, while typical dissolved solids constituents include Al, Ba, Ca, Fe, Li, Mg, Mn, Na, and Sr in the form of chlorides, carbonates, and sulfates. Additional F/P water components include suspended solids, bacteria, and normally occurring radioactive material.

TABLE 1
Key Flowback and Produced Water Contaminants

| | Concentration |
|---|---|
| Constituent | (mg/L) |
| Ba | 2,300-6,500 |
| Ca | 5,100-18,000 |
| Fe | 11-60 |
| Mg | 4440-1,300 |
| Mn | 2-5 |
| TDS | 69,000-300,000 |
| Hydrocarbon | 40-1,000 |
| TSS | 100-500 |

Conventional F/P water disposal currently used by the gas industry consists of separating F/P water from proppant and gas, followed by interim flowback water storage. The flowback water is then transported to a disposal pit, evaporation pond, or recycling facility offsite. A more attractive fluid management option is to reuse F/P water in subsequent drilling activities. However, F/P water cannot simply be reused due to its host of components which can interfere with subsequent hydrofracturing activities.

The present invention provides a cost-effective F/P water treatment process for onsite operation, allowing water to remain within the field and thereby reducing water demand and need to transport F/P water offsite.

### SUMMARY

The present invention is premised on the realization that F/P water from hydraulically fractured wells can be treated for reuse by separating impurities using a combination of chemical and mechanical separation techniques. According to the present invention, the F/P water can be treated using one or more of a hydrocyclone particulate filter, an ultra-violet (UV) treatment unit, a sulfonation unit, a softening unit, a hydrolysis unit to remove targeted dissolved solids, and a radioactive material adsorption unit.

In addition to these one or more treatment units, the F/P water is introduced into a tilted supercritical vessel that heats the water to a supercritical temperature causing the water to exhibit non-polar behavior. This, in turn, causes the remaining dissolved solids to precipitate. The precipitated solids and the clean purified water flow toward a bottom end of the tilted supercritical vessel and are discharged at substantially similar axial locations along the length of the supercritical vessel.

In addition, any hydrocarbons present in the fluid will decompose and undergo water/gas shift reaction, forming hydrogen and carbon dioxide. The hydrogen and carbon dioxide. This gas mixture can be used, in part, along with well head gas to power super critical reactor either directly or through the use of an electrical generator.

According to an exemplary embodiment, a supercritical vessel for separating dissolved solids from a fluid solution includes a main body defining a separation chamber adapted to contain a fluid solution while the fluid solution is heated to a supercritical temperature so as to produce a supercritical fluid from which dissolved solids precipitate. The supercritical vessel further includes a fluid inlet provided on the main body and adapted to direct the fluid solution into the separation chamber, a fluid outlet provided on the main body and adapted to discharge supercritical fluid from the separation chamber, and a precipitate outlet provided on the main body and adapted to discharge the precipitated solids from the separation chamber. The main body is tilted at a tilt angle relative to horizontal such that the fluid inlet is positioned vertically higher than the fluid outlet and the precipitate outlet, so as to induce movement of the precipitated solids in a downward direction toward the precipitate outlet.

A supercritical vessel according to another exemplary embodiment includes a main body having a first and second opposed ends and defining a separation chamber therebetween adapted to contain a fluid solution while the fluid solution is heated to a supercritical temperature so as to produce a supercritical fluid from which dissolved solids precipitate. The supercritical vessel further includes a fluid inlet provided on the main body proximate the first end and adapted to direct the fluid solution into the separation chamber, a fluid outlet provided on the main body and adapted to discharge supercritical fluid from the separation chamber, and a precipitate outlet provided on the main body and adapted to discharge the precipitated solids from the separation chamber. The fluid outlet and the precipitate outlet may each be disposed proximate the second end of the main body.

An exemplary method of separating dissolved solids from a fluid solution in a supercritical vessel is also provided. The supercritical vessel includes a main body defining a separation chamber, a fluid inlet, a fluid outlet, and a precipitate outlet. The method includes tilting the supercritical vessel at a tilt angle relative to horizontal such that the fluid inlet is positioned vertically higher than the fluid outlet and the precipitate outlet. The method further includes directing a fluid solution through the fluid inlet and into the separation chamber of the tilted supercritical vessel. The fluid solution in the separation chamber is subjected to a supercritical temperature and a supercritical pressure so as to produce a supercritical fluid from which dissolved solids precipitate. The precipitated solids are induced by the tilted orientation of the supercritical vessel to move in a downward direction toward the precipitate outlet. At least a portion of the supercritical fluid is discharged through the fluid outlet, and at least a portion of the precipitated solids is discharged through the precipitate outlet.

### BRIEF DESCRIPTION OF THE DRAWINGS

The accompanying drawings, which are incorporated in and constitute a part of this specification, illustrate an embodiment of the invention and, together with a general description of the invention given above, and the detailed description given below, serve to explain the invention.

FIG. 1 is a diagrammatic view of a system and method for treating F/P water according to an embodiment of the invention.

FIG. 2 is a schematic side front view of a tilted supercritical vessel of the system of FIG. 1, according to an embodiment of the invention.

FIG. 3 is a schematic cross-sectional side view of the tilted supercritical vessel of FIG. 2.

### DETAILED DESCRIPTION

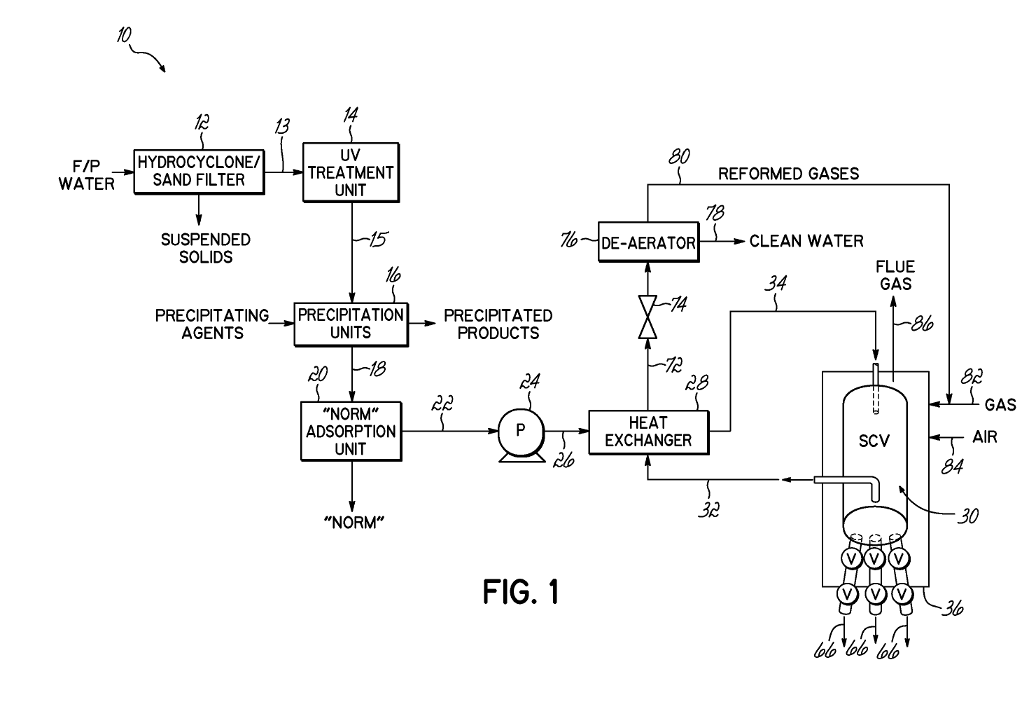

Referring to FIG. 1, a system 10 according to an embodiment of the invention is designed to purify flowback and produced water from an oil or gas well, referred to herein as “F/P water” or “waste water.” The system 10 preferably includes an initial particle separator 12 designed to remove suspended particles from the waste water. The particular separator 12 may be, for example, a hydrocyclone/sand filter. However, other types of filters can be used. The system 10 further includes a biological treatment unit 14 coupled to the particle separator by line 13 and designed to destroy microorganisms present in the waste water. The treatment unit 14 can be, for example, an ultraviolet light treatment unit, an ozonator, or simply a chemical treatment unit utilizing common biocides and bacteriacides. Generally, an ultraviolet treatment unit or an ozonator are preferred as these units do not add any additional chemicals to the waste water.

The system 10 further includes one or more separate precipitation units 16 coupled to the biological treatment unit 14 by line 15 and designed to remove various ions from the waste water. The precipitation units 16 may include, for example, a sulfonation unit to remove barium and strontium from the waste water, by adding sulfuric acid, which will cause the barium and/or strontium to precipitate out of solution as sulfates. The precipitation units 16 can also include a separate softening unit for removing calcium and magnesium from the waste water. This effect is accomplished by mixing sodium carbonate into the waste water, which will cause the formation of calcium and/or magnesium carbonates, which will, again, precipitate out of solution. The precipitation units 16 may also include a hydrolysis unit for removing iron and/or magnesium from the waste water. This effect would be accomplished by adding hydroxide to the waste water to produce hydroxides of the iron or manganese which, again, will precipitate out of solution. Any one or a combination of these individual units 16 may be employed in the system 10 as desired depending on the types of ions present in the waste water to be treated. Additionally, while the biological treatment unit 14 is shown upstream of the precipitation units 16, it will appreciated that in alternative embodiments the biological treatment unit 14 may be positioned downstream of the precipitation units 16.

The precipitation units 16 are connected via conduit 18 to a radiation adsorption unit or norm adsorption unit 20, which is designed to remove normally occurring radioactive material from the waste stream. Adsorption units are well known. These may include, for example, barium sulfate or other adsorbant to adsorb the radioactive material within the waste stream mainly Ra 226 and Ra 228. The adsorption unit 20 can also be located upstream of the precipitation units 16 or downstream of the heat exchanger 28.

The radioactive material adsorption unit 20 is connected via conduit 22 to a high pressure pump 24, which is connected via line 26 to a heat exchanger 28. The heat exchanger 28 receives supercritical clean water emitted from a supercritical vessel (“SCV”) 30, described in greater detail below, through conduit 32 and transmits heat from the emitted heated clean water to the incoming cooler waste water received through line 26. After passing from the line 26 and through the heat exchanger 28, the pre-heated waste water then flows through conduit 34 and into the supercritical vessel 30.

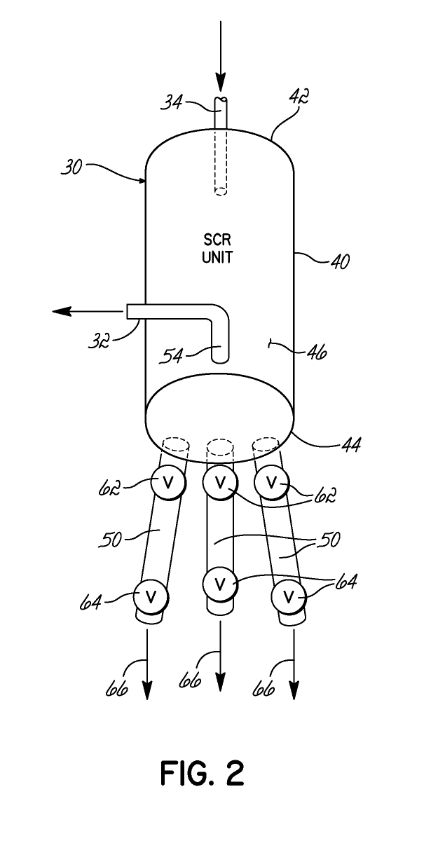

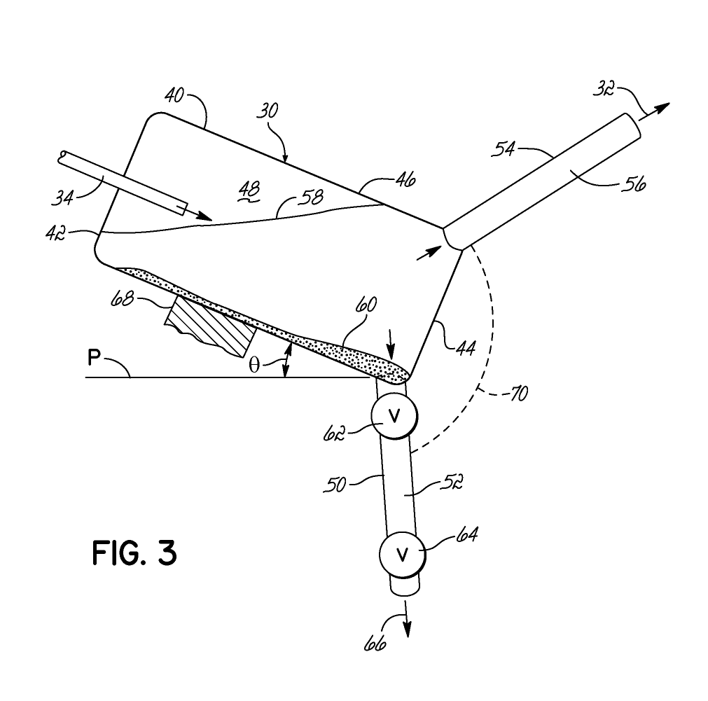

Referring to FIGS. 2 and 3, an embodiment of the supercritical vessel 30 of the system 10 is shown schematically. The supercritical vessel 30 is a high-pressure vessel adapted to receive the pre-heated waste water and maintain supercritical conditions of the waste water, including a supercritical temperature and a supercritical pressure, so that dissolved solids within the waste water solution may precipitate and be removed. As shown schematically in FIG. 1, the supercritical vessel 30 is enclosed within a furnace 36, which heats the supercritical vessel 30 sufficiently to achieve the desired supercritical temperature of the waste water within the vessel 30.

The supercritical vessel 30 includes a main body 40 having an inlet end 42, an outlet end 44, and an outer sidewall 46, and defining an inner separation chamber 48. The conduit 34 is coupled to the inlet end 42, and may extend partially into the separation chamber 48, for directing pre-heated waste water received from the heat exchanger 28 into the separation chamber 48. One or more precipitate discharge legs 50 extends outwardly from the outlet end 44 of the main body 40 and defines a respective precipitate chamber 52 that communicates with the separation chamber 48 and that is adapted to receive and retain solids that precipitate from the waste water, as described below. A clean fluid discharge leg 54 also extends outwardly from the outlet end 44 of the main body 40 and defines a clean fluid discharge passage 56 that communicates with the separation chamber 48 at one end and with the conduit 32 at another end. The clean fluid discharge leg 54 is adapted to direct supercritical clean water 58, from which solids 60 have precipitated in the separation chamber 48, into the conduit 32 for circulation to the heat exchanger 28, as described above and below.

As shown in FIGS. 2 and 3, the supercritical vessel 30 may include three precipitate discharge legs 50 and one clean fluid discharge leg 54. The precipitate discharge legs 50 extend from a portion of the main body 40 that is substantially diametrically opposed from (e.g., positioned circumferentially 180 degrees from) a portion of the main body 40 from which the clean fluid discharge leg 54 extends. Additionally, as shown, each of the precipitate discharge legs 50 and the fluid discharge leg 54 may project angularly (e.g., radially and axially outward) from the main body 40 so as to form an obtuse angle (e.g., greater than 90 degrees) with the outer sidewall 46. It will be understood that any one or more of the discharge legs 50, 54 may extend from the main body 40 at any suitable angle, for example a right angle (e.g., 90 degrees).

Furthermore, the precipitate discharge legs 50 and the fluid discharge leg 54 may extend from the main body 40 at substantially similar axial locations along a longitudinal axis of the main body 40. For example, the precipitate discharge legs 50 and the fluid discharge leg 54 may extend from the same axial location along the longitudinal axis of the main body 40. In particular, as shown in the illustrated embodiment, the precipitate and fluid discharge legs 50, 54 may extend from the main body 40 at or near the outlet end 44. This configuration, in combination with the tilted orientation of the supercritical vessel 30 described below, advantageously enables the removal of clean water 58 and precipitated solids 60 from the separation chamber 48 at the downwardly positioned outlet end 44, thereby simplifying the equipment and process used for purifying the waste water. In alternative embodiments, the discharge legs 50, 54 may be positioned at any suitable locations along the length of the main body 40. Additionally, it will be appreciated that any suitable quantity and arrangement of precipitate discharge legs 50 and clean fluid discharge legs 54 may be provided. As shown and described, each of the precipitate discharge legs 50 functions as an outlet for precipitated solids 60, and the clean fluid discharge leg 54 functions as an outlet for clean supercritical water 58.

The main body 40 and the discharge legs 50, 54 may each be substantially tubular in shape with substantially constant respective diameters. The discharge legs 50, 54 may be straight, or they may include one or more bends, as exemplified by clean fluid discharge leg 54. Additionally, the inlet and outlet ends 42, 44 of the main body 40 may be substantially flat or contoured. For example, either or both of the inlet and outlet ends 42, 44 may be convex such that they curve axially outward from the separation chamber 48. Moreover, the main body 40 may be sized such that the separation chamber 48 defines an internal volume substantially greater than an internal volume of each of the precipitate discharge legs 50 and the clean fluid discharge leg 54. The internal volumes defined by the precipitate discharge legs 50 may be uniform or varied, and each may be greater than, equal to, or less than an internal volume defined by the clean fluid discharge leg 54. In alternative embodiments, the main body 40 and the discharge legs 50, 54 may be formed with various alternative suitable shapes and relative sizes.

Each of the precipitate discharge legs 50 may include an upper valve 62 and a lower valve 64 for selectively controlling an outlet flow of precipitated solids 60 from the separation chamber 48. In particular, the upper valve 62 separates the precipitate chamber 52 from the separation chamber 48, and controls a flow of precipitated solids from the separation chamber 48 into the precipitate chamber 52. The lower valve 64 separates the precipitate chamber 52 from a conduit 66, or a container (not shown), that receives the discharged precipitated solids 60 and conveys it to or stores it for safe disposal. The lower valve 64 thus controls a discharge of the precipitated solids from the precipitate chamber 52. The upper valve 62 may be positioned at or near an upper end of the precipitate discharge leg 50, and the lower valve 64 may be positioned at or near an opposed lower end of the precipitate discharge leg 50. The precipitate chamber 52 is defined between the upper valve 62 and the lower valve 64.

Referring to FIG. 3, the supercritical vessel 30 is positioned such that a longitudinal axis of the main body 40 is tilted at an angle θ relative to a substantially horizontal reference plane P, which may be a ground surface or other support surface, such that the outlet end 44 of the vessel 30 is positioned vertically lower than the inlet end 42. Thus, the inlet conduit 34 is positioned vertically higher than the precipitate and fluid discharge legs 50, 54 relative to the horizontal reference plane P. As described in greater detail below, incoming waste water entering the supercritical vessel 30 through conduit 34 is heated to supercritical conditions in the separation chamber 48 and is thereby separated into supercritical clean water 58 and precipitated solids 60 at a central interior portion of the separation chamber 48. Gravitational forces induce movement, or flow, of the supercritical clean water 58 and the precipitated solids 60 in a downward direction toward the outlet end 44 of the supercritical vessel 30, so that they may be discharged from the separation chamber 48. The precipitated solids 60 slide down along the tilted outer sidewall 46 of the main body 40 toward the precipitate discharge legs 50, and may temporarily settle and collect at the outlet end 44 before entering and being discharged through one or more of the precipitate discharge legs 50.

The supercritical vessel 30 may be supported at any suitable positive tilt angle θ, by a vessel support element 68 for example, for inducing continuous or semi-continuous movement of the precipitated solids 60 and supercritical clean water 58 toward the outlet end 44. The vessel support element 68 may be in the form of one or more legs, one or more support walls, or other suitable stand-like support structures, for example, which may be formed integrally with or separately from the main body 40 of the vessel 30. In exemplary embodiments, the supercritical vessel 30 may be supported at a tilt angle θ that is greater than 0 degrees and less than 90 degrees. In one embodiment, the tilt angle θ may be equal to or greater than the angle of repose of the solid precipitate 60, for example. Additionally, as shown, the supercritical vessel 30 may be formed such that when the vessel 30 is positioned at the desired tilt angle θ, the precipitate discharge legs 50 are substantially perpendicular (e.g., vertical) to the horizontal reference plane P.

As shown schematically in FIG. 3, a fluid bypass line 70 may extend between the clean fluid discharge leg 54 and one or more of the precipitate discharge legs 50, such that the clean fluid discharge passage 56 communicates with the precipitate chamber 52 through the bypass line 70. In use, a portion of the supercritical clean water 58 passing into the clean fluid discharge passage 56 may be directed through the bypass line 70 into an empty precipitate chamber 52, thereby pressurizing the precipitate chamber 52 and equalizing the pressures within the separation chamber 48 and the precipitate chamber 52. In this manner, pressure gradients and operational disruptions are mitigated when first opening the upper valve 62 of an empty precipitate discharge leg 50.

The supercritical vessel 30 may be formed of any suitable material or combination of materials adapted to safely maintain supercritical conditions, including supercritical temperatures and pressures, within the vessel 30. The inner surfaces of the supercritical vessel 30 may be coated with a ceramic film or high temperature resistant silicone coating to help prevent solids deposition. Additionally, the inner surfaces of the vessel 30 may be etched to produce a surface that inhibits solids deposition.

Referring back to FIG. 1, the clean water 58 emitted from the supercritical vessel 30 at a supercritical temperature is directed through conduit 32 and through the heat exchanger 28, where heat is exchanged from the super heated clean water to the waste water received from conduit 26. As a result of passing through the heat exchanger 28, the temperature of the clean water 58 is reduced below supercritical conditions. The cooled clean water 58 then passes through conduit 72, through a pressure regulator valve 74, and into a de-aerator 76. The de-aerator 76 operates to separate reformed gases from the clean water 58. The clean water 58, in turn, is discharged from line 78 and the re-formed gases are emitted from the de-aerator through outlet line 80 and are combined with an inlet line 82 and introduced into the furnace 36, which surrounds the supercritical vessel 30. Air is also introduced into the furnace 36 through line 66 to provide combustion gases, and thus heat. Combustion products exit the furnace 36 through line 86.

Having described the structural configuration of the exemplary system 10, an exemplary method of operating the system 10 will now be described. Referring to FIGS. 1-3, the waste water, or F/P water, from the fractured well, which can be held in a storage tank (not shown), is introduced into the particle separator 12. The particle separator 12 provides a physical removal of suspended solids generally down to a particle size of about 0.1-10 micron. The waste water then passes through line 13 into the biological treatment unit 14. Ultraviolet and ozone-based treatment units are well known, and form no part of the present invention. The biological treatment unit 14 will either kill or sterilize bacteria and other microorganisms, which prevents fouling of the downstream components in the system 10.

The waste water, after passing through the biological treatment unit 14, then is introduced through line 15 into a series of precipitation units 16. As described above, based on the contents of the waste water, the particular precipitation units 16 utilized may vary in type. For example, if barium or strontium is present in the waste water, a sulfonation unit may be utilized to cause the barium or strontium to precipitate in response to the addition of sulfuric acid, which would cause the formation of barium sulfate and/or strontium sulfate. Generally, an amount of sulfuric acid up to about 1000 mmol/L is added to cause the barium and strontium to precipitate. The barium sulfate can be collected and used as an adsorbant in the radiation adsorption unit 20 located downstream, if desired. It is preferable to remove barium before hydrolysis because Ba(OH)₂, which would then form in the hydrolysis unit, is toxic. Some strontium may remain in solution due to the presence of chloride ions.

If calcium or magnesium is present in the waste water, a softening unit can be utilized to cause the calcium and/or magnesium to precipitate. This can be accomplished by the addition of sodium carbonate. In one embodiment, up to approximately 800 mmol/L of sodium carbonate may be added in the softening unit. Finally, if there is iron or manganese present in the waste water, these ions can be removed by adding sufficient sodium hydroxide to establish a basic pH, thereby causing the iron and manganese to precipitate out of solution. The hydrolysis treatment also removes remaining carbonates because they precipitate with pH increase, which reduces downstream scale formation. The added hydroxide also inhibits corrosion in the supercritical vessel 30.

The waste water from the precipitation unit 16 then passes through line 18 into the radioactive material adsorption unit 20. Such adsorption units are well known and form no part of the present invention. In an alternative embodiment, the adsorption method may be replaced by the widely used NaEZ separation method, employed at the end of the system 10.

The waste water from the radioactive material adsorption unit 20 passes through line 22 to the feed pump 24. The feed pump 24 increases the waste water pressure to at least about 3,200 psia and up to about 3,480 psia, and generally to about 3,250 psia. After pressurization via the feed pump 24, the waste water flows though line 26 into the heat exchanger 28, which transfers thermal energy from the heated clean water received from the supercritical vessel 30 through line 32, to the waste water received through line 26. Generally, the temperature of the waste water leaving the heat exchanger 28 through line 34 will be about approximately 360° C. to 390° C., and in particular approximately 380° C. It will be understood that the temperature of the waste water in line 34, prior to entering the supercritical vessel 30, is below the supercritical temperature of the waste water.

After passing through the heat exchanger 28, the waste water is directed through line 34 into the separation chamber 48 of the supercritical vessel 30. The supercritical vessel 30 is heated by the furnace 36 with combusted well head gas and air introduced through lines 82 and 84, respectively. The furnace 36 heats the main body 40 of the supercritical vessel 30, thereby heating waste water within the separation chamber 48, to above the super critical temperature of the waste water, which is generally at least about 410° C. Scale formation on the inner walls of the supercritical vessel 30 may be avoided by establishing the supercritical temperature of the waste water, and resulting precipitation of solids, at a central interior portion of the separation chamber 48.

As the waste water reaches the supercritical temperature in the separation chamber 48, the remaining dissolved salts in the waste water begin to precipitate out of waste water solution due to the changing nature of the supercritical fluid. When the waste water reaches a supercritical state, its density dramatically decreases and the hydrogen bonding is significantly reduced, thereby making the waste water behave as a non-polar liquid. Thus, the ionic salts remaining in the waste water are no longer soluble and precipitate out of waste water solution in the separation chamber 48 of the supercritical vessel 30, leaving behind supercritical clean water 58. These precipitated solids 60 then fall onto an inner surface of the sidewall 46 of the supercritical vessel 30.

Due to the tilted orientation of the supercritical vessel 30 described above, the precipitated solids 60 are induced, by gravitational force, downwardly along the inner surface of the sidewall 46 and toward the outlet end 44 of the supercritical vessel 30. These solids 60 may settle at the outlet end 44 and flow into any one or more of the precipitate chambers 52. Flow of the precipitated solids 60 into the precipitate chambers 52 is controlled by selectively opening or closing one or more of the upper valves 62 of the respective precipitate discharge legs 50. For example, to direct precipitated solids 60 into a particular precipitate chamber 52, the upper valve 62 corresponding to that precipitate chamber 52 is opened while the lower valve 64 corresponding to that precipitate chamber 52 is closed. Once the precipitate chamber 52 has been filled with solids 60 to an adequate degree, the upper valve 62 may be closed and the lower valve 64 opened to discharge the solids 60 from the precipitate chamber 52. While precipitated solids 60 are collected into the one or more precipitate chambers 52, supercritical clean water 58 is directed out through the clean fluid discharge passage 56. Advantageously, because the portion of the main body 40 of the supercritical vessel 30 from which the solids 60 are discharged is substantially diametrically opposed from the portion of the main body 40 from which the supercritical clean water 58 is discharged, the risk of back mixing and entraining precipitated solids 60 within the supercritical clean water 58 is minimized.

In embodiments in which the supercritical vessel 30 includes multiple precipitate discharge legs 50, the respective precipitate chambers 52 may be filled and discharged sequentially via sequential operation of the upper and lower valves 62, 64 of the respective precipitate discharge legs 50. For example, the upper valve 62 of a first precipitate discharge leg 50 may be opened to direct solids into a corresponding first precipitate chamber 52, while the upper valves 62 of second and third precipitate discharge legs 50 remain closed. Once the first precipitate chamber 52 has filled to an adequate degree, its upper valve 62 may be closed and its lower valve 64 opened to discharge the solids therein. Simultaneously, or shortly thereafter, the upper valve 62 of the second precipitate discharge leg 50 may be opened to direct solids 60 into the second precipitate chamber 52. The filling and discharging process may be repeated for the second and third precipitate discharge legs 50, sequentially, eventually cycling back to filling of the first precipitate chamber 52. Accordingly, separation of precipitated solids 60 from the supercritical clean water 58 in the supercritical vessel 30 may be performed substantially continuously, or at last semi-continuously.

As described above, while a precipitate chamber 52 is being filled with solids 60, the next precipitate chamber 52 to be filled may be pressurized with supercritical clean water 58 received through fluid bypass line 70 while its respective upper valve 62 remains closed, thereby advantageously equalizing the internal pressure of the closed precipitate chamber 52 with the separation chamber 48. In alternative embodiments, the multiple precipitate chambers 52 may be filled and discharged in pairs, or in unison. As described above, the discharged solids 60 are then safely disposed of, as indicated at 66. Simultaneously, the supercritical clean water 58 is directed through clean fluid discharge leg 54 back toward the heat exchanger 28 via conduit 32.

At the same time that the dissolved ionic salts in the waste water are precipitating, any hydrocarbon present in the waste water, as well as other organic material, will undergo a water/gas shift reaction in which the hydrocarbons react with steam to form hydrogen and carbon monoxide and, subsequently, again react with steam to form hydrogen and carbon dioxide. This gaseous mixture is contained within the supercritical clean water passing through line 32. In one embodiment, in order to promote re-forming of aromatic hydrocarbons, the supercritical vessel 30 can include a low-cost reforming catalyst and a mild oxidizing agent. The catalyst and oxidizing agent are used to promote initial carbon bonding destruction, allowing the supercritical clean water 58 to then reform the remaining hydrocarbons. The catalyst can be, for example, a heterogenous nickel-base catalyst provided on a support element (not shown) within the supercritical vessel 30. The oxidizing agent may include air, peroxides, perchlorates, ozone, permanganates, or others, for example.

After passing through the heat exchanger 28 via line 32, the cooled clean water 58 passes through line 72 and through valve 74 to de-aerator 76, which separates the gas from the clean water 58. The clean water 58 is then discharged through line 78. This clean water can then be reused in the fracturing process or can be discharged into the environment or into a waste water disposal system. The gases are directed through line 80 and back to line 82 where they are mixed with the well head gases used as a fuel for the furnace 36. The combustible gas combined with the air are used to heat the supercritical vessel 30, as described above. The combustion products exit the furnace 36 through line 86.

Methods of purifying waste water using the system 10 described herein may reduce operating costs by reducing water supply disposal and transportation expenses, and may recover up to 95% of the waste water as a reusable water product. Advantageously, the disclosed purifying process removes all major waste constituents, allowing the water to be discharged to a local environment, and eliminates the need for water disposal trucks. Further, the separated waste products obtained can be used. For example, the barium sulfate can be used in the norm adsorption unit, and the salts obtained from the supercritical vessel 30 can be applied to roads as road salt. There are also commercial uses for the calcium carbonate, barium carbonate, strontium carbonate, calcium hydroxide, magnesium hydroxide, and iron hydroxide. Thus, the disclosed purifying process does not require that these byproducts be disposed of in a land fill.

While the supercritical vessel 30 and related methods for separating dissolved particles from waste water are shown and described herein in connection with the components of system 10, it will be understood that the supercritical vessel 30 may be used in connection with any other suitable waste water treatment system.

Moreover, while the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. A supercritical vessel for separating dissolved solids from a fluid solution, comprising:
a main body defining a separation chamber adapted to contain a fluid solution while the fluid solution is heated to a supercritical temperature so as to produce a supercritical fluid from which dissolved solids precipitate;
a fluid inlet provided on the main body and adapted to direct the fluid solution into the separation chamber;
a fluid outlet provided on the main body and adapted to discharge supercritical fluid from the separation chamber; and
a precipitate outlet provided on the main body and adapted to discharge the precipitated solids from the separation chamber,
wherein the main body is tilted at a tilt angle relative to horizontal such that the fluid inlet is positioned vertically higher than the fluid outlet and the precipitate outlet, so as to induce movement of the precipitated solids in a downward direction toward the precipitate outlet.

2. The supercritical vessel of claim 1, wherein the fluid outlet is diametrically opposed from the precipitate outlet.

3. The supercritical vessel of claim 1, wherein the main body is tilted to a tilt angle that is greater than or equal to an angle of repose of the precipitated solids.

4. The supercritical vessel of claim 1, wherein the precipitate outlet includes a plurality of precipitate discharge legs.

5. The supercritical vessel of claim 4, wherein the precipitate outlet includes three precipitate discharge legs.

6. The supercritical vessel of claim 4, wherein each of the precipitate discharge legs includes at least one valve, the at least one valve being movable between an open position and a closed position to selectively control discharge of the precipitated solids from the separation chamber.

7. A supercritical vessel for separating dissolved solids from a fluid solution, comprising:
a main body having a first and second opposed ends and defining a separation chamber therebetween adapted to contain a fluid solution while the fluid solution is heated to a supercritical temperature so as to produce a supercritical fluid from which dissolved solids precipitate;
a fluid inlet provided on the main body proximate the first end and adapted to direct the fluid solution into the separation chamber;
a fluid outlet provided on the main body and adapted to discharge supercritical fluid from the separation chamber; and
a precipitate outlet provided on the main body and adapted to discharge the precipitated solids from the separation chamber,
wherein the fluid outlet and the precipitate outlet are each disposed proximate the second end of the main body.

8. The supercritical vessel of claim 7, wherein the fluid outlet and the precipitate outlet are each disposed at substantially similar axial locations along a longitudinal axis of the main body.

9. The supercritical vessel of claim 7, wherein the fluid outlet is substantially diametrically opposed from the precipitate outlet.

10. The supercritical vessel of claim 7, wherein the precipitate outlet includes a plurality of precipitate discharge legs.

11. The supercritical vessel of claim 10, wherein the precipitate outlet includes three precipitate discharge legs.

12. The supercritical vessel of claim 10, wherein each of the precipitate discharge legs includes at least one valve, the at least one valve being movable between an open position and a closed position to selectively control discharge of the precipitated solids from the separation chamber.

13. A method of separating dissolved solids from a fluid solution in a supercritical vessel including a main body defining a separation chamber, a fluid inlet, a fluid outlet, and a precipitate outlet, the method comprising:
tilting the supercritical vessel at a tilt angle relative to horizontal such that the fluid inlet is positioned vertically higher than the fluid outlet and the precipitate outlet;
directing a fluid solution through the fluid inlet and into the separation chamber of the tilted supercritical vessel;
subjecting the fluid solution in the separation chamber to a supercritical temperature and a supercritical pressure so as to produce a supercritical fluid from which dissolved solids precipitate, wherein the precipitated solids are induced by the tilted orientation of the supercritical vessel to move in a downward direction toward the precipitate outlet;
discharging at least a portion of the supercritical fluid through the fluid outlet and discharging at least a portion of the precipitated solids through the precipitate outlet.

14. The method of claim 13, wherein discharging the supercritical fluid and the precipitated solids includes discharging the supercritical fluid and the precipitated solids from substantially similar axial locations along a longitudinal axis of the main body of the tilted supercritical vessel.

15. The method of claim 13, wherein the precipitate outlet includes at least one precipitate discharge leg having at least one valve, the method further comprising:
selectively opening and closing the at least one valve to control a rate of discharge of the precipitated solids through the precipitate discharge leg.

16. The method of claim 15, wherein the precipitate outlet includes a plurality of precipitate discharge legs, each having at least one valve, the method further comprising:
sequentially opening and closing the valves of the plurality of precipitate discharge legs.

17. The method of claim 15, wherein the at least one precipitate discharge leg includes a precipitate chamber adapted to receive the precipitated solids from the separation chamber, the method further comprising:
pressurizing the precipitate chamber.

18. The method of claim 13, wherein discharging the precipitated solids from the separation chamber includes discharging the precipitated solids continuously.
